(19) United States
(12) Patent Application Publication
(10) Pub. No.: US 2007/0175494 A1
(43) Pub. Date: Aug. 2, 2007

(54) ELECTRODE CLEANING USING ELECTRICAL PULSE

(76) Inventors: Ivar Giaever, Schenectady, NY (US); Charles R. Keese, Schoharie, NY (US)

Correspondence Address: HOFFMAN WARNICK & D'ALESSANDRO, LLC, 75 STATE STREET, 14TH FLOOR, ALBANY, NY, 12207, US

(21) Appl. No.: 11/670,464

(22) Filed: Feb. 2, 2007

Related U.S. Application Data
(60) Provisional application No. 60/764,617, filed on Feb. 2, 2006.

(51) Int. Cl. B08B 3/12

(52) U.S. Cl. 134/1

(57) ABSTRACT

Cleaning an electrode used for acquiring measurement data while the electrode is contacting a medium using a set of electrical pulses. An electrical pulse causes a voltage drop between approximately 0.01 Volts and approximately 10 Volts across the electrode. A particular voltage drop and/or other aspects of the pulse(s) can be selected based on the voltage source, electrode, medium, and/or the like. In an illustrative embodiment, the voltage drop is between approximately 1.0 and approximately 1.5 volts.

### REFERENCE TO RELATED APPLICATION

The current application claims the benefit of co-pending U.S. Provisional Application No. 60/764,617, titled “Impedance restoration”, which was filed on 2 Feb. 2006, and which is hereby incorporated herein by reference.

### FIELD OF THE INVENTION

Aspects of the invention relate generally to cleaning an electrode, and more particularly, to a solution for cleaning an electrode using an electrical pulse.

### BACKGROUND OF THE INVENTION

Cell behavior, such as morphology changes and cell motions in animal cells that attach and spread out and crawl on the bottom of tissue culture vessels, can be monitored using electrical sensing. For example, as shown and described in U.S. Pat. No. 5,187,096, which is hereby incorporated by reference, cell behavior can be passively analyzed by applying a weak alternating current (AC) electric current across one or more electrodes with which cell(s) may come in contact. In particular, cells can be grown on an electrode mounted to a bottom of a small well; a much larger counter electrode can complete an electrical circuit. A standard tissue culture medium can be used as an electrolyte. For monitoring, a weak (e.g., approximately 1 microampere) AC current (usually in the frequency range from 100 to 40,000 Hertz) is applied to the system.

In addition to monitoring cell behavior, electricity can be used to wound cells. For example, as shown and described in the co-pending U.S. patent application Ser. No. 10/163,322, titled “Electrical wounding assay for cells in vitro”, which was filed on 5 Jun. 2002, and which is hereby incorporated by reference, a high pulse of current can be applied to wound cells in contact with an electrode. In this case, the wounding pulse of current can last for a few seconds, have a current of approximately a few milliamperes that results in a voltage drop of approximately 1 volt across the cell layer, and when an AC current is used, a frequency within a range of frequencies between 10,000 and 60,000 Hertz. Additionally, a shorter wounding pulse of current (e.g., 200 milliseconds) can be used to electroporate the cells allowing a cytotoxic agent to permeate and kill the cell(s).

To accurately monitor cell behavior using electrical sensing, it is desirable that the properties of the electrode(s) be stable so that any measured electrical changes (e.g., impedance) can be attributed to the cells and not confused with drifts in the properties of the electrode(s). One approach cleans an electrode with oxygen plasma etching and places the electrode in a protein-containing culture medium, within which the electrode acquires an adsorbed protein coat. Electrodes treated in this manner have been shown to have well defined impedance values that remain stable over several days. However, over time, the impedance will start to become considerably higher. The impedance can be subsequently restored by, for example, soaking the electrodes in a tissue culture medium for an hour or more.

### BRIEF SUMMARY OF THE INVENTION

Aspects of the invention provide a solution for cleaning an electrode used for acquiring measurement data while the electrode is contacting a medium using a set of electrical pulses. An electrical pulse causes a voltage drop between approximately 0.01 Volts and approximately 10 Volts across the electrode. A particular voltage drop and/or other aspects of the pulse(s) can be selected based on the voltage source, electrode, medium, and/or the like. In an illustrative embodiment, the voltage drop is between approximately 1.0 and approximately 1.5 volts.

A first aspect of the invention provides a method of managing an electronic measurement system, the method comprising: contacting an electrode with a medium; and cleaning the electrode while the electrode is contacting the medium, the cleaning including: applying an electrical pulse to the electrode, the pulse causing a voltage drop between approximately 0.01 Volts and approximately 10 Volts across the electrode.

A second aspect of the invention provides an electronic measurement system comprising: an electrode; a system for obtaining electronic measurement data based on the electrode and a medium contacting the electrode; and a system for cleaning the electrode while the electrode is contacting the medium, the system for cleaning including a system for applying an electrical pulse to the electrode, the pulse causing a voltage drop between approximately 0.01 Volts and approximately 10 Volts across the electrode.

A third aspect of the invention provides a computer program comprising program code stored on a computer-readable medium, which when executed, enables a computer system to implement a method of managing an electronic measurement system, the method comprising: cleaning an electrode in the electronic measurement system while the electrode is contacting a medium, the cleaning including directing a voltage source to apply an electrical pulse to the electrode, the pulse causing a voltage drop between approximately 0.01 Volts and approximately 10 Volts across the electrode; and obtaining electronic measurement data based on the electrode and the medium.

A fourth aspect of the invention provides a method of generating an electronic measurement system, the method comprising: providing a computer system operable to: obtain electronic measurement data based on an electrode and a medium contacting the electrode; and clean the electrode while the electrode is contacting the medium by applying an electrical pulse to the electrode, the pulse causing a voltage drop between approximately 0.01 Volts and approximately 10 Volts across the electrode.

The illustrative aspects of the invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention.

FIG. 1 shows an illustrative environment for obtaining electronic measurement data according to an embodiment of the invention.

FIG. 2 shows a more detailed view of an illustrative measurement apparatus according to an embodiment of the invention.

FIG. 3 shows an illustrative series of pulses for cleaning an electrode according to an embodiment of the invention.

FIG. 4 shows an illustrative flow diagram for obtaining measurement data for a medium according to an embodiment of the invention.

It is noted that the drawings are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide a solution for cleaning an electrode used for acquiring measurement data while the electrode is contacting a medium using a set of electrical pulses. An electrical pulse causes a voltage drop between approximately 0.01 Volts and approximately 10 Volts across the electrode. A particular voltage drop and/or other aspects of the pulse(s) can be selected based on the voltage source, electrode, medium, and/or the like. In an illustrative embodiment, the voltage drop is between approximately 1.0 and approximately 1.5 volts. As used herein, unless otherwise noted, the term “set” means one or more (i.e., at least one) and the phrase “any solution” means any now known or later developed solution.

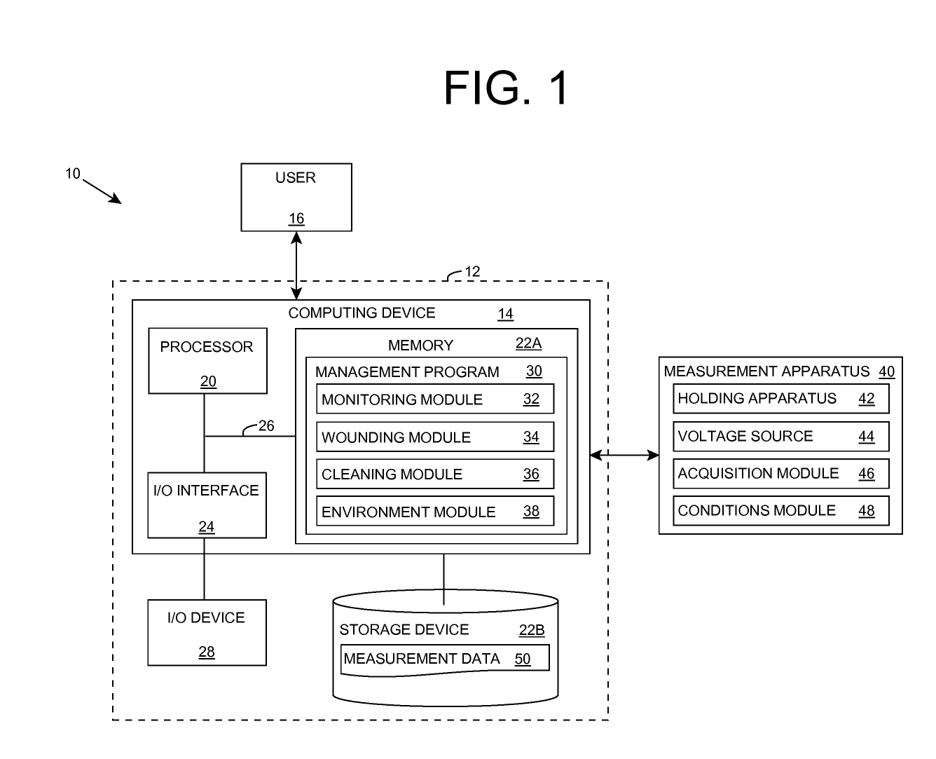

Turning to the drawings, FIG. 1 shows an illustrative environment 10 (e.g., electronic measurement system) for managing electronic measurement data 50 according to an embodiment of the invention. To this extent, environment 10 includes a computer system 12 that can perform the processes described herein in order to manage an electronic measurement apparatus 40 and measurement data 50. In particular, computer system 12 is shown including a computing device 14 that comprises a management program 30, which makes computing device 14 operable to obtain measurement data 50 using measurement apparatus 40 and manage measurement data 50 by performing the processes described herein.

Computing device 14 is shown including a processor 20, a memory 22A, an input/output (I/O) interface 24, and a bus 26. Further, computing device 14 is shown in communication with an external I/O device/resource 28 and a storage device 22B. In general, processor 20 executes program code, such as management program 30, which is at least partially stored in a storage system, such as memory 22A and/or storage device 22B. While executing program code, processor 20 can read and/or write data, such as measurement data 50, to/from memory 22A, storage device 22B, and/or I/O interface 24. Bus 26 provides a communications link between each of the components in computing device 14, while I/O interface 24 provides a communications link between computing device 14 and one or more I/O devices 28. I/O device 28 can comprise any device that transfers data between a user 16 and computing device 14. To this extent, I/O device 28 can comprise a human-usable I/O device to enable an individual user 16 to interact with computing device 14 and/or a communications I/O device to enable another system, such as measurement apparatus 40 and/or a system user 16, to communicate with computing device 14 using any type of communications link.

In any event, computing device 14 can comprise any general purpose computing article of manufacture capable of executing program code installed thereon. However, it is understood that computing device 14 and management program 30 are only representative of various possible equivalent computing devices that may perform the process described herein. To this extent, in other embodiments, the functionality provided by computing device 14 and management program 30 can be implemented by a computing article of manufacture that includes any combination of general and/or specific purpose hardware and/or program code. In each embodiment, the program code and hardware can be created using standard programming and engineering techniques, respectively.

Similarly, computer system 12 is only illustrative of various types of computer systems for implementing aspects of the invention. For example, in one embodiment, computer system 12 comprises two or more computing devices that communicate over any type of communications link to perform the processes described herein. Further, while performing the processes described herein, one or more computing devices in computer system 12 can communicate with one or more other computing devices external to computer system 12 using any type of communications link. In either case, each communications link can comprise any combination of various types of wired and/or wireless links; comprise any combination of one or more types of networks; and/or utilize any combination of various types of transmission techniques and protocols. Additionally, it is understood that some or all of the functions discussed herein can be manually implemented, without the use of computer system 12.

In any event, management program 30 obtains measurement data 50 from measurement apparatus 40. Management program 30 can manage measurement data 50 using any solution. For example, measurement data 50 can be stored as one or more files in a file system, which can define various objects/structures that can be manipulated (e.g., modified, added, deleted, etc.) in a dynamic memory using management program 30 and subsequently stored in the one or more files. Similarly, measurement data 50 can be stored in a relational database or the like. Additionally, management program 30 can enable user 16 to request action(s) to be performed on measurement data 50. To this extent, management program 30 can generate a user interface for display to a human user 16, which enables user 16 to obtain, view, modify, delete, and/or the like measurement data 50. Further, management program 30 can define an application program interface (API) or the like that enables similar functionality for a system user 16.

As discussed herein, management program 30 enables computer system 12 to manage measurement apparatus 40 and obtain measurement data 50 acquired using measurement apparatus 40. To this extent, management program 30 is shown including a monitoring module 32, a wounding module 34, a cleaning module 36, and an environment module 38. Operation of each of these modules is discussed further herein. However, it is understood that some of the various modules shown in FIG. 1 can be implemented independently, combined, and/or stored in memory of one or more separate computing devices that are included in computer system 12. Further, it is understood that some of the modules and/or functionality may not be implemented, or additional modules and/or functionality may be included as part of computer system 12.

Regardless, aspects of the invention provide a solution for managing electronic measurement apparatus 40. Measurement apparatus 40 can include a holding apparatus 42, a voltage source 44, an acquisition module 46, and a conditions module 48. In general, holding apparatus 42 includes a container within which a sample to be measured is held. Holding apparatus 42 also includes a set of electrodes to which voltage source 44 can apply a current. Acquisition module 46 can obtain electronic measurement data 50 based on the current and one or more electrical properties of the electrode(s) in holding apparatus 42. Conditions module 48 can adjust one or more aspects of an environment within holding apparatus 42.

Management program 30 (and/or a human user 16) controls one or more aspects of the operation of measurement apparatus 40. For example, management program 30 can control an amount of voltage supplied by voltage source 44 to each electrode in holding apparatus 42, control acquisition module 46 and obtain measurement data 50 therefrom, control conditions module 48 to adjust one or more aspects of the environment for a sample, and/or the like. Management program 30 can control the operation of measurement apparatus 40 using any automated, partially automated, and/or manual solution. To this extent, management program 30 can provide an interface (e.g., user interface, API, and/or the like) between user 16 and measurement apparatus 40 that enables user 16 to define and/or request an automated process, select one or more operational parameters, perform a manual operation, and/or the like, which management program 30 can implement with measurement apparatus 40.

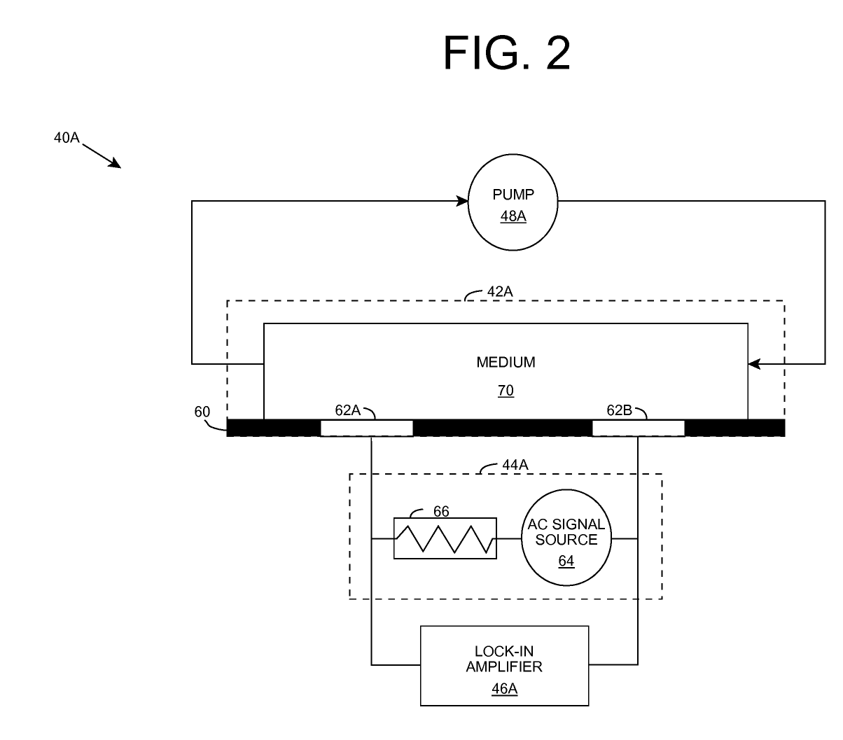

FIG. 2 shows a more detailed view of an illustrative measurement apparatus 40A according to an embodiment of the invention. Holding apparatus 42A includes a substrate 60 with a set of electrodes 62A-B mounted thereon. Substrate 60 can comprise any type of substrate. In an embodiment of the invention, substrate 60 comprises a printed circuit board that includes an electrical contact and wiring for connecting each electrode 62A-B to a circuit. Any number, size, shape, pattern, etc., of electrode(s) 62A-B can be included in substrate 60. Similarly, each electrode 62A-B can comprise any type of conductive material, such as a thin gold film. Additionally, electrode(s) 62A-B can be treated. For example, electrode(s) 62A-B can be treated with oxygen plasma etching, coated with a particular type of macromolecule, e.g., extracellular matrix proteins, and/or the like.

Holding apparatus 42A can be configured to form a set of wells, each of which can hold a medium 70 in place on a portion of substrate 60 that includes a set of electrodes 62A-B. Medium 70 can comprise any type of electrically conductive medium, such as an electrolyte, that contacts an electrode 62A-B and/or completes a circuit between two or more electrodes 62A-B in a well. Medium 70 can include any type of electrolyte, such as a saline solution (e.g., saline, phosphate buffered saline, other salt solutions, etc.), a tissue culture medium, and/or the like. Additionally, medium 70 can include additional content, such as one or more proteins, a cysteine or cysteine-like compound, serum, an agent (e.g., cytotoxic agent), and/or the like. Still further, medium 70 can include a cell culture that is added below, within, and/or above the electrolyte. Even further, medium 70 can comprise a liquid (e.g., water or other type of solution), a gel, and/or the like.

Electrode(s) 62A-B are electrically connected to a voltage source 44A. Voltage source 44A is shown including an AC signal source 64 and a resistor 66. In operation, voltage source 44A applies an AC current through resistor 66 and electrode 62A. Current then flows through medium 70 and (counter) electrode 62B to complete the circuit. In measurement apparatus 40A, acquisition module 46A comprises a lock-in amplifier, which can obtain measurement data 50 (FIG. 1) based on one or more electrical characteristics (e.g., impedance, capacitance, etc.) of the electrical circuit using any solution. In general, measurement data 50 will change as one or more cells in medium 70 come in contact with electrode(s) 62A-B. For example, when measurement data 50 comprises impedance, the impedance will rise as cell(s) contact electrode(s) 62A-B. Additionally, conditions module 48A comprises a pump, which can vary a flow of medium 70 over substrate 60 using any solution.

It is understood that measurement apparatus 40A is only illustrative of numerous possible embodiments of a measurement apparatus under the invention. To this extent, alternative embodiments of measurement apparatus 40 (FIG. 1) can include fewer components (e.g., no conditions module 48A), alternative components, additional components, or any combination thereof. Similarly, each component can implement less functionality, alternative functionality (e.g., a direct current (DC) voltage source), additional functionality, or any combination thereof. For example, conditions module 48 could adjust a temperature, pressure, air/medium 70 composition, and/or the like inside holding apparatus 42A. Additionally, acquisition module 46A can obtain additional measurement data 50, such as data on the environment within holding apparatus 42A (e.g., flow rate, temperature, pressure, and/or the like).

Regardless, referring to FIGS. 1 and 2, management program 30 can manage the operation of some or all of the various components in measurement apparatus 40A. For example, monitoring module 32 can direct voltage source 44A to apply a current having a particular set of characteristics (e.g., voltage, frequency, etc.) for a particular period of time (automatically or manually determined). In this case, the current can have characteristics that enable monitoring module 32 to obtain measurement data 50 from lock-in amplifier 46A without adversely impacting medium 70 (e.g., the health of cell(s) that may come in contact with electrodes 62A-B). Similarly, wounding module 34 can direct voltage source 44A to apply a current having a particular set of characteristics, direct environment module 48 to introduce one or more agents, and/or the like, which is designed to wound/kill a portion of medium 70 (e.g., one or more cells in contact with electrodes 62A-B). Further, environment module 38 can direct pump 48A to provide a desired flow rate for medium 70 across substrate 60.

According to various embodiments of the invention, cleaning module 36 cleans one or more electrodes 62A-B prior to monitoring and/or wounding medium 70. For example, while medium 70 (e.g., an electrolyte) is contacting the electrode(s) 62A-B, cleaning module 36 can direct voltage source 44A to apply a set of electrical pulses to electrode(s) 62A-B, which will clean the electrode(s) 62A-B. The cleaning can occur prior to the introduction of any cells within the well (e.g., within medium 70). Alternatively, the cleaning can occur after cells have been introduced within the well, but before any cells are anticipated to be in contact with electrode(s) 62A-B (e.g., cells are placed above a gel medium 70). In any event, the electrical pulse(s) can cause a voltage drop between approximately 0.01 volts and approximately 10 volts across electrode(s) 62A-B. A desired voltage drop and/or type of voltage (e.g., alternating or direct current) can be selected based on the type of electrode 62A-B, the content of medium 70, voltage source 44A, and/or the like.

Similarly, a frequency of the electrical pulse(s) can be selected based on one or more characteristics of electrode(s) 62A-B, medium 70, voltage source 44A, and/or the like. To this extent, the frequency can be in a range between approximately 1 Hertz and approximately 1 Megahertz. Further, a length of time and/or nature of the electrical pulse(s) can be selected based on one or more characteristics of electrode(s) 62A-B, medium 70, voltage source 44A, and/or the like. To this extent, the length of time of an electrical pulse can be in a range between approximately 0.1 millisecond to several hundreds of seconds, while the nature of the electrical pulse(s) can range from a single, continuous electrical pulse to multiple pulses each of which includes any type of fixed or varying voltage drop (e.g., square wave, saw tooth, ramped, and/or the like). When multiple pulses are used, it is understood that each pulse can be the same as other pulses or one or more characteristics of a pulse can differ from another pulse.

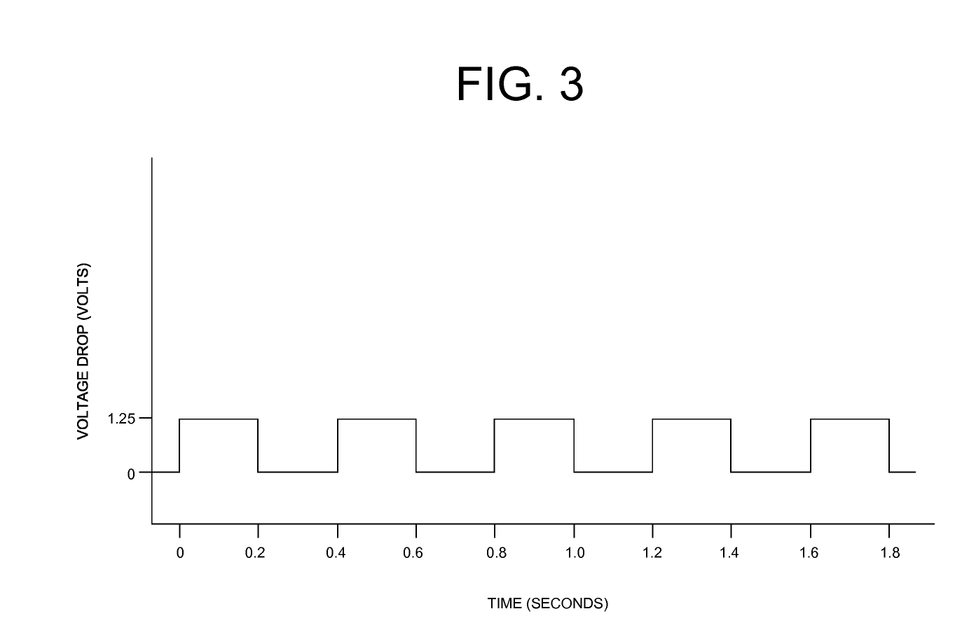

In an illustrative implementation, electrode(s) 62A-B comprise a thin gold film. In this case, a series of relatively short (e.g., approximately 200 milliseconds) pulses can be used to avoid damaging electrode(s) 62A-B. Briefly referring also to FIG. 3, an illustrative series of pulses for cleaning electrode(s) 62A-B according to an embodiment of the invention is shown. In this case, medium 70 can comprise a tissue culture medium with ten percent serum added. Cleaning module 36 cleans electrodes 62A-B with a series of electrical pulses, each of which has a voltage drop of approximately 1.25 volts across the interface between electrode 62A-B and medium 70. The series of electrical pulses includes five pulses, each lasting approximately 200 milliseconds and separated by an approximately 200 millisecond gap during which voltage source 44A stops providing any current across electrode 62A-B. The frequency of each pulse can comprise approximately 10,000 Hertz.

It is understood that the frequency of a pulse and/or the voltage generated by voltage source 44A to obtain the voltage drop can vary based on operating aspects of a particular measurement apparatus 40. For example, holding apparatus 42A can include eight wells, each of which includes a relatively small (e.g., 250 micrometer diameter) gold electrode 62A and a much larger counter electrode 62B to complete the circuit with voltage source 44A. In this case, for a pulse having a voltage drop of approximately 1.25 volts, AC signal source 64 can apply a signal having a voltage of approximately 0.8 volts and a frequency of approximately 10,000 Hertz through a resistor 66 having a resistance of approximately 1000 Ohms.

In an alternative configuration of holding apparatus 42A, each of eight wells includes ten relatively small gold electrodes 62A connected in parallel and a larger counter electrode 62B to complete the circuit. In this case, AC signal source 64 can apply a signal having a voltage of approximately five volts and a frequency of approximately 10,000 Hertz through a resistor 66 having a resistance of approximately 1000 Ohms to yield a pulse having a voltage drop of approximately 1.25 volts across each electrode 62A-B.

In another alternative configuration of holding apparatus 42A, each of eight wells includes two sets of twenty small gold electrodes 62A-B connected in parallel without a counter electrode. In this case, AC signal source 64 can apply a signal having a voltage of approximately five volts and a frequency of approximately 4,000 Hertz through a resistor 66 having a resistance of approximately 1000 Ohms to yield a pulse having a voltage drop of approximately 1.25 volts across each electrode 62A-B.

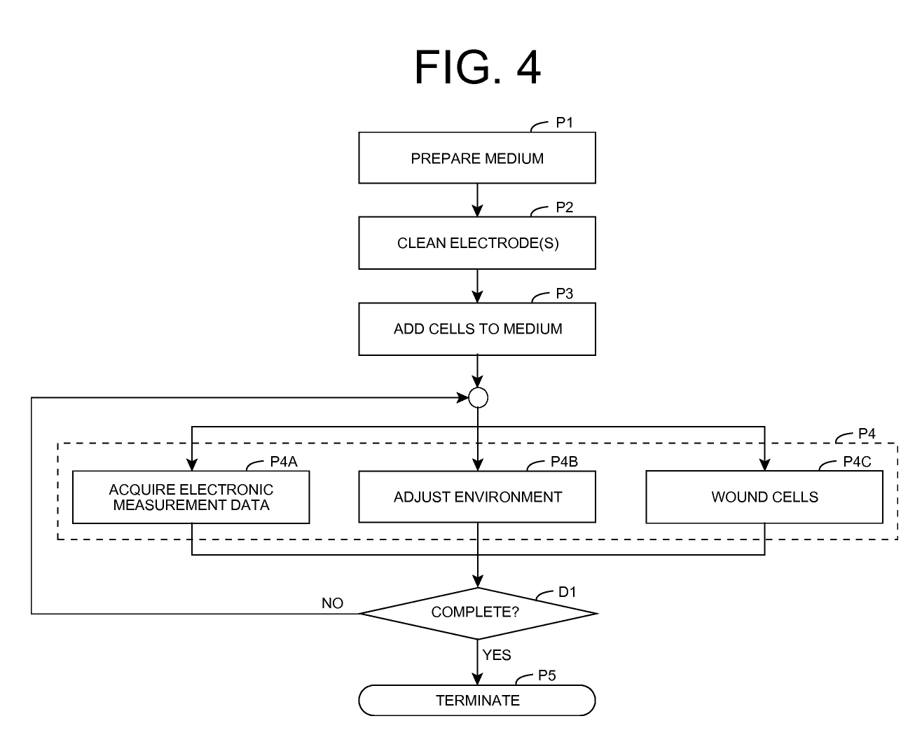

FIG. 4 shows an illustrative flow diagram for obtaining measurement data 50 for a medium 70 according to an embodiment of the invention. Referring to FIGS. 1 and 4, in process P1, medium 70 (FIG. 2) is prepared. Preparation of medium 70 can include placing medium 70 in contact with electrode(s) 62A-B (FIG. 2) (e.g., by pouring medium 70 into a well), adding one or more agents to medium 70, allowing a liquid to form a gel, and/or the like.

Prior to process P1, electrode(s) 62A-B (FIG. 2) may be treated to obtain a “pristine” condition having a well defined impedance value. For example, electrode(s) 62A-B can be cleaned with oxygen plasma etching and placed in a protein-containing culture medium to acquire an adsorbed protein coat resulting in a relatively well defined impedance value for electrode(s) 62A-B. Over time, the impedance value may increase while electrode(s) 62A-B are exposed to air prior to process P1, which may be due to air molecules (e.g., organic material such as plasticizers) adsorbing on the service of electrode(s) 62A-B. As a result, in process P2, cleaning module 36 cleans electrode(s) 62A-B. For example, cleaning module 36 can direct voltage source 44 to generate a set of pulses, such as those shown in FIG. 3, to restore an impedance of each electrode 62A-B to a previous (e.g., pristine) state. The pulse(s) may form electrochemical species that interact with the electrode surface, displaying the material (e.g., air molecules) that are fouling electrode(s) 62A-B. Regardless, the pulse(s) do not adversely impact an adsorbed protein coat, if present. In an embodiment of the invention, when medium 70 (FIG. 2) includes a cell culture, process P2 is performed when no cells are in contact with electrode(s) 62A-B.

In process P3, cells are added to medium 70 (FIG. 2) using any solution. In an embodiment of the invention, the addition of cells includes adding additional medium 70. For example, process P3 can include adding cells and/or additional medium as shown and described in the co-pending U.S. patent application Ser. No. ______ (Attorney Docket No. APPL-0005), filed on _______, and entitled “Electrical measurement of vertical cell movement”, which is hereby incorporated by reference. In any event, processes P1-3 can be implemented using any manual, computer-assisted (e.g., prompts), semi-automated, or automated solution. In each non-manual solution, management program 30 (FIG. 1) can implement the functionality required for the solution. For example, cells can be cultured in process P3, during which environment module 38 can operate conditions module 48 to maintain a particular temperature, pressure, and/or the like, monitoring module 32 can operate one or more components of acquisition module 46 to obtain measurement data 50 on the environment, etc.

Subsequently, in process P4 an experiment is implemented for medium 70 (FIG. 2). To this extent, the experiment includes, in process P4A, monitoring module 32 operating acquisition module 46 and/or voltage source 44 and acquiring electronic measurement data 50 based on electrode(s) 62A-B (e.g., impedance measurements). Additionally, the experiment may include, in process P4B, environment module 38 operating conditions module 48 to vary one or more aspects of the environment within holding apparatus 42. Further, the experiment may include, in process P4C, wounding module 34 operating voltage source 44 and/or conditions module 48 to wound cellular matter (e.g., cell(s), organism(s), and/or the like) being studied within medium 70.

Process P4 is repeated until in decision D1, management program 30 determines that the experiment is complete (e.g., time expires, manually stopped, or the like). In process P5, management program 30 can terminate the operation of the various components of measurement apparatus 40. It is understood that the flow diagram of FIG. 4 is only illustrative of numerous possible process flows, which may include additional process(es), fewer process(es), alternative process(es), processes performed in different order and/or in parallel, and/or the like. For example, the order of processes P2 and P3 can be reversed when the cells are unlikely to come in contact with electrode(s) 62A-B prior to the performance of process P2.

While shown and described herein as a method and system for managing an electronic measurement system, it is understood that the invention further provides various alternative embodiments. For example, in one embodiment, the invention provides a computer program stored on a computer-readable medium, which when executed, enables a computer system to manage an electronic measurement system. To this extent, the computer-readable medium includes program code, such as management program 30 (FIG. 1), which implements some or all of the processes described herein. It is understood that the term “computer-readable medium” comprises one or more of any type of tangible medium of expression capable of embodying a copy of the program code (e.g., a physical embodiment). In particular, the computer-readable medium can comprise program code embodied on one or more portable storage articles of manufacture, on one or more data storage portions of a computing device, such as memory 22A (FIG. 1) and/or storage system 22B (FIG. 1), as a data signal traveling over a network (e.g., during a wired/wireless electronic distribution of the computer program), on paper (e.g., capable of being scanned and converted to electronic data), and/or the like.

In another embodiment, the invention provides a method of generating a system for managing an electronic measurement system. In this case, a computer system, such as computer system 12 (FIG. 1), can be obtained (e.g., created, maintained, having made available to, etc.) and one or more programs/systems for performing some or all of the processes described herein can be obtained (e.g., created, purchased, used, modified, etc.) and deployed to the computer system. To this extent, the deployment can comprise one or more of: (1) installing program code on a computing device, such as computing device 14 (FIG. 1), from a computer-readable medium; (2) adding one or more computing devices to the computer system; and (3) incorporating and/or modifying one or more existing devices of the computer system, to enable the computer system to perform some or all of the processes described herein.

As used herein, it is understood that “program code” means any set of statements or instructions, in any language, code or notation, that cause a computing device having an information processing capability to perform a particular function either directly or after any combination of the following: (a) conversion to another language, code or notation; (b) reproduction in a different material form; and/or (c) decompression. To this extent, program code can be embodied as any combination of one or more types of computer programs, such as an application/software program, component software/a library of functions, an operating system, a basic I/O system/driver for a particular computing, storage and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method of managing an electronic measurement system, the method comprising:
contacting an electrode with a medium; and
cleaning the electrode while the electrode is contacting the medium, the cleaning including:
applying an electrical pulse to the electrode, the pulse causing a voltage drop between approximately 0.01 Volts and approximately 10 Volts across the electrode.

2. The method of claim 1, the cleaning further including repeating the applying for at least one additional pulse.

3. The method of claim 2, the cleaning including a gap between each pulse having a duration of approximately 200 milliseconds.

4. The method of claim 1, the pulse having a duration between approximately 0.1 milliseconds and approximately 100 seconds.

5. The method of claim 1, the pulse having a duration of approximately 200 milliseconds.

6. The method of claim 1, the pulse comprising an alternating current electrical pulse.

7. The method of claim 6, the pulse having a frequency between approximately 1 Hertz and approximately 1 Megahertz.

8. The method of claim 6, the pulse having a frequency of approximately 10,000 Hertz.

9. The method of claim 1, the voltage drop being approximately 1.25 Volts.

10. The method of claim 1, the medium comprising a saline solution.

11. The method of claim 1, the medium including a protein.

12. The method of claim 1, further comprising adding a cell culture to the electrolyte.

13. The method of claim 1, further comprising applying a monitoring current to the electrode.

14. The method of claim 1, further comprising applying a wounding current to the electrode.

15. An electronic measurement system comprising:
an electrode;
a system for obtaining electronic measurement data based on the electrode and a medium contacting the electrode; and
a system for cleaning the electrode while the electrode is contacting the medium, the system for cleaning including a system for applying an electrical pulse to the electrode, the pulse causing a voltage drop between approximately 0.01 Volts and approximately 10 Volts across the electrode.

16. The system of claim 15, further comprising a system for applying a monitoring current to the electrode.

17. The system of claim 15, further comprising a system for applying a wounding current to the electrode.

18. The system of claim 15, further comprising a system for adjusting at least one aspect of an environment for the medium.

19. The system of claim 15, the electronic measurement data comprising an impedance.

20. A computer program comprising program code stored on a computer-readable medium, which when executed, enables a computer system to implement a method of managing an electronic measurement system, the method comprising:
cleaning an electrode in the electronic measurement system while the electrode is contacting a medium, the cleaning including directing a voltage source to apply an electrical pulse to the electrode, the pulse causing a voltage drop between approximately 0.01 Volts and approximately 10 Volts across the electrode; and
obtaining electronic measurement data based on the electrode and the medium.

21. The computer program of claim 20, the obtaining including directing the voltage source to apply a monitoring current to the electrode.

22. The computer program of claim 20, the method further comprising directing the voltage source to apply a wounding current to the electrode.

23. The computer program of claim 20, the method further comprising directing a component to adjust at least one aspect of an environment for the medium.

24. A method of generating an electronic measurement system, the method comprising:
providing a computer system operable to:
obtain electronic measurement data based on an electrode and a medium contacting the electrode; and
clean the electrode while the electrode is surrounded by the medium by applying an electrical pulse to the electrode, the pulse causing a voltage drop between approximately 0.01 Volts and approximately 10 Volts across the electrode.
